(19) United States
(12) Patent Application Publication
(10) Pub. No.: US 2017/0268962 A1
(43) Pub. Date: Sep. 21, 2017

(54) METHODS AND SYSTEMS FOR MONITORING HEALTH OF A COMBUSTOR

(71) Applicant: NUOVO PIGNONE TECNOLOGIE Srl, Florence (IT)

(72) Inventors: Aninda Bhattacharya, Bangalore (IN); Ravi Yoganatha Babu, Bangalore (IN); Kesavan Dhanasekaran, Bangalore (IN); Riccardo Garbin, Rapallo (Genova) (IT); Marzia Sepe, Arcidosso (Grosseto) (IT)

(21) Appl. No.: 15/071,766

(22) Filed: Mar. 16, 2016

(51) Int. Cl. G01M 15/14; F02C 3/14

(52) U.S. Cl. CPC G01M 15/14; F02C 3/14; F05D 2260/83

(57) ABSTRACT

In accordance with one embodiment, a system is presented. The system includes a casing, a combustor disposed within the casing, and a sensing device located on the casing and configured to sense a plurality of acoustic emission waves and generate an electrical signal based on the sensed plurality of acoustic emission waves. The system further includes a processing subsystem operationally coupled to the sensing device and configured to determine one or more features based on the electrical signal, and determine a presence or an absence of fretting wear in the combustor based at least on the one or more features.

### BACKGROUND

Embodiments of the present invention relate generally to wear monitoring systems and more particularly to a system and method for monitoring fretting wear of a combustor.

A combustor of a gas turbine generates hot combustion gases which drives a turbine. The turbine, in turn, drives a compressor that provides compressed air for combustion in the combustor. In addition, the turbine produces usable output power. In one example, a combustor for a gas turbine may be configured as a circular array of cylindrical combustion chambers to receive compressed air from the compressor, mix the compressed air and fuel for generating a combustion reaction, and generate hot combustion gases.

A liner of the combustor operates in a high temperature environment. Liner stoppers and casing stoppers are provided to prevent tangential, radial, and translational motion of the liner due to combustion dynamics Heat and vibration from the combustion processes, as well as other mechanical loads and stresses from the gas turbine may shake, rattle and otherwise vibrate the liner. Specifically, liner stoppers and casing stoppers are mounted around the liner within a combustion flow sleeve.

During operation, various components of the combustor may rub against each other resulting in fretting wear. For example, the liner stopper may rub against the casing resulting in fretting wear followed by a crack in the liner stopper or the liner. Typically, defects in the combustor can be detected by disassembling the combustor which results in shutdown of the gas turbine.

Accordingly, there is a need for a method and system that predict and determine defects in a combustor without disassembling the combustor.

### BRIEF DESCRIPTION

In accordance with one embodiment, a system is presented. The system includes a casing, a combustor disposed within the casing, and a sensing device located on the casing and configured to sense a plurality of acoustic emission waves and generate an electrical signal based on the sensed plurality of acoustic emission waves. The system further includes a processing subsystem operationally coupled to the sensing device and configured to determine one or more features based on the electrical signal, and determine a presence or an absence of fretting wear in the combustor based at least on the one or more features.

In accordance with another embodiment, a method for determining fretting wear in a combustor is presented. The method includes sensing a plurality of acoustic emission waves, generating an electrical signal based on the sensed plurality of acoustic emission waves, determining one or more features based on the electrical signal, and determining a presence or an absence of the fretting wear in the combustor based at least on the one or more features.

### DRAWINGS

These and other features and aspects of embodiments of the present invention will become better understood when the following detailed description is read with reference to the accompanying drawings in which like characters represent like parts throughout the drawings, wherein:

FIG. 1 is a block diagram of a system for monitoring fretting wear of a combustor of a gas turbine engine in accordance with one embodiment of the present invention;

FIG. 2 is a partial cross sectional view of a combustor in accordance with an embodiment the present invention;

FIG. 3 is a flow chart that illustrates an exemplary method for monitoring fretting wear of a combustor of a gas turbine engine in accordance with one embodiment of the present invention;

FIG. 4 is a flow chart that illustrates an exemplary method for monitoring fretting wear of a combustor of a gas turbine engine in accordance with another embodiment of the present invention; and

FIG. 5 is an example of a simulated electrical signal for determining one of more time domain features, in accordance with one embodiment of the present invention.

### DETAILED DESCRIPTION

Embodiments of the present system and method disclose monitoring the fretting wear of a combustor based on acoustic emission waves. For example, the embodiments of the present system and method disclose monitoring the fretting wear of a combustor based on acoustic emission waves transmitted through a casing of the combustor. Specifically, embodiments of the present system and method disclose determining whether fretting wear exists in the combustor by processing the acoustic emission waves.

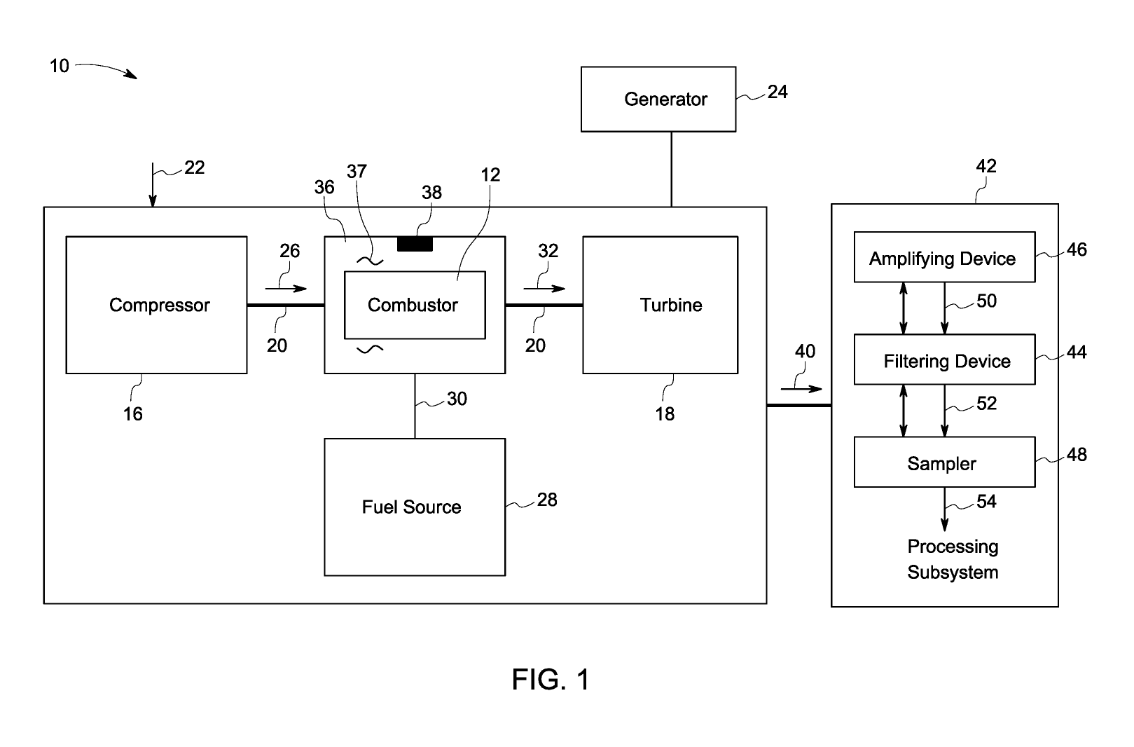

FIG. 1 is a block diagram of a system 10 for monitoring the fretting wear of a combustor 12 of a gas turbine engine 14 in accordance with one embodiment of the present invention. The gas turbine engine 14 includes a compressor 16, the combustor 12, and a turbine 18 interconnected via a rotatable shaft(s) 20. It should be noted herein that although FIG. 1 discloses monitoring the fretting wear of the combustor 12 of the gas-turbine engine 14, the present systems and methods may be applicable to any device or system that includes a combustor.

The compressor 16 is configured to pressurize the atmospheric air 22 to provide pressurized air 26 to the combustor 12. The system 10 further includes a fuel source 28 that is configured to supply a fuel 30 to the combustor 12. The fuel 30 is mixed with the pressurized air 26 and combusted in the combustor 12 to generate combustion gases 32 carrying heat energy (not shown). The combustion gases 32 are directed from the combustor 12 to the turbine 18. The combustion gases 32 flow through between turbine blades (not shown) located in the turbine 18 resulting in expansion of the combustion gases 32. The turbine 18 drives the compressor 16 via the shaft(s) 20. Further, the turbine 18 drives a generator 24 to generate electric power.

In the illustrated embodiment, the combustor 12 is disposed within a casing 36. One or more sensing devices 38 are located on the casing 36. In one embodiment, the one or more sensing devices 38 may be located on an inner surface of the casing 36. In another embodiment, the one or more sensing devices 38 may be located on an outer surface of the casing 38. In yet another embodiment, the one or more sensing devices 38 may be located on one or more perforations in the casing 36. The one or more sensing devices 38, for example, may include an acoustic emission sensor, an accelerometer, a static pressure sensor, a dynamic pressure sensor or the like.

The one or more sensing devices 38 are configured to sense a plurality of acoustic emission waves 37 generated from the combustor 12, for example. The one or more sensing devices 38, for example, are configured to sense the acoustic emission waves 37 characterized by a frequency range of 100 kHz to 1.5 MHz. In one embodiment, the one or more sensing devices 38 are configured to sense the acoustic emission 37 waves transmitted through the casing 36 of the combustor 12. The one or more sensing devices 38 are further configured to generate an electrical signal 40 based on the sensed acoustic emission waves 37.

The system 10 further includes a processing subsystem 42 operationally coupled to the gas turbine engine 14 and the one or more sensing devices 38. In particular, the processing subsystem 42 is operationally coupled to the one or more sensing devices 38. The processing subsystem 42, for example may be a digital signal processor, a microprocessor, a microcomputer, a microcontroller, and/or any other suitable device. The processing subsystem 42 is configured to receive the electrical signal 40 from the gas turbine engine 14. Particularly, the processing subsystem 42 is configured to receive the electrical signal 40 from the one or more sensing devices 38.

In the illustrated embodiment, the processing subsystem 42 includes a filtering device 44, an amplifying device 46, and a sampler 48. The amplifying device 46 is operationally coupled to the one or more sensing devices 38 and is configured to receive the electrical signal 40 from the one or more sensing devices 38. The one or more sensing devices 38 may generate the electrical signal 40 characterized by high impedance that is unsuitable for transmission over cables. Hence, the amplifying device 46 transforms the electrical signal 40 characterized by high impedance to a low impedance electrical signal 50. Furthermore, in certain embodiments, the amplifying device 46 may amplify the electrical signal 40 characterized by high impedance to a voltage range that is suitable for the processing subsystem 42 and/or the filtering device 44. It should be noted herein that although the amplifying device 46 is shown as a part of the processing subsystem 42, the amplifying device 46 may be separate from the processing subsystem 42. The amplifying device 46, for example, may be electronic equipment, an electronic device, an electronic circuit or a module of the processing subsystem 42.

The processing subsystem 42 may further include the filtering device 44. The filtering device 44, for example, may be a module, a microprocessor, a microcomputer, a microcontroller, and/or any other suitable device, a module or a software code. In one embodiment, the filtering device 44 is operationally coupled to the amplifying device 46. The filtering device 44 is configured to filter the low impedance electrical signal 50 to generate a filtered electrical signal 52. In one embodiment, the filtering device 44, for example may include a band pass filter.

The sampler 48 is operationally coupled to the filtering device 44 and is configured to receive the filtered electrical signal 52. The sampler 48, for example, may be a module of the processing subsystem 42. The sampler 48 is configured to sample the filtered electrical signal 52 to generate a discrete electrical signal 54.

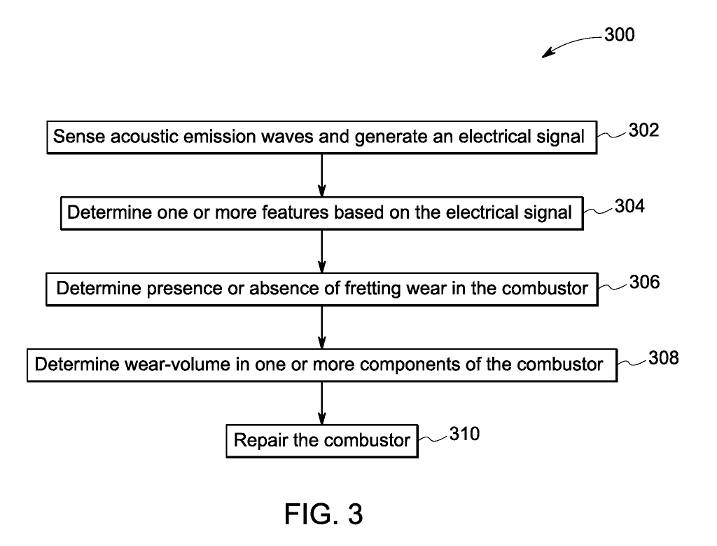

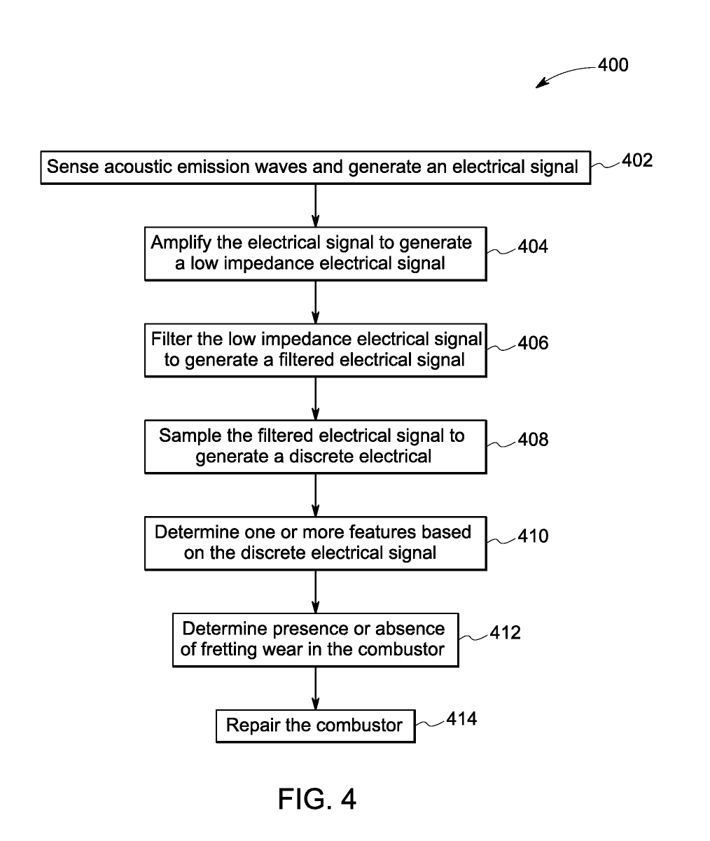

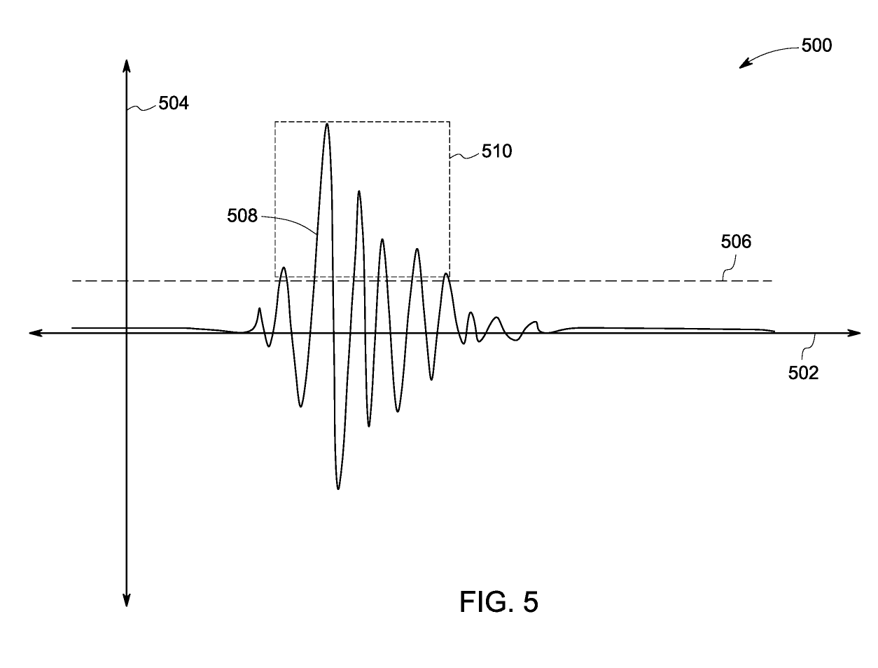

The processing subsystem 42 is configured to monitor the fretting wear of the combustor 12 based on the electrical signal 40. In one embodiment, the processing subsystem 42 is configured to monitor the fretting wear of the combustor 12 based on the discrete electrical signal 54. In one embodiment, the processing subsystem 42 is configured to determine one or more features based on the electrical signal 40 or the discrete electrical signal 54. The one or more features, for example, include a burst amplitude, a burst energy, a burst count, or the like. As used herein, the term “burst amplitude” refers to a maximum amplitude of an electrical signal generated for a determined time period. As used herein, the term “burst count” refers to a determined number of times, an electrical signal exceeds a predetermined voltage threshold. The burst energy, for example may be proportional to an area of the electrical signal 40 or the discrete electrical signal 54. The processing subsystem 42 is further configured to determine a presence or an absence of fretting wear in the combustor 12 based on the one or more features. In one embodiment, the processing subsystem 42 is further configured to determine the presence or the absence of the fretting wear in the combustor 12 based on a load of the gas-turbine engine 14 and the one or more features. The determination of fretting wear, for example, is explained in greater detail with reference to FIG. 3 and FIG. 4. Furthermore, the features, for example are shown with reference to FIG. 5.

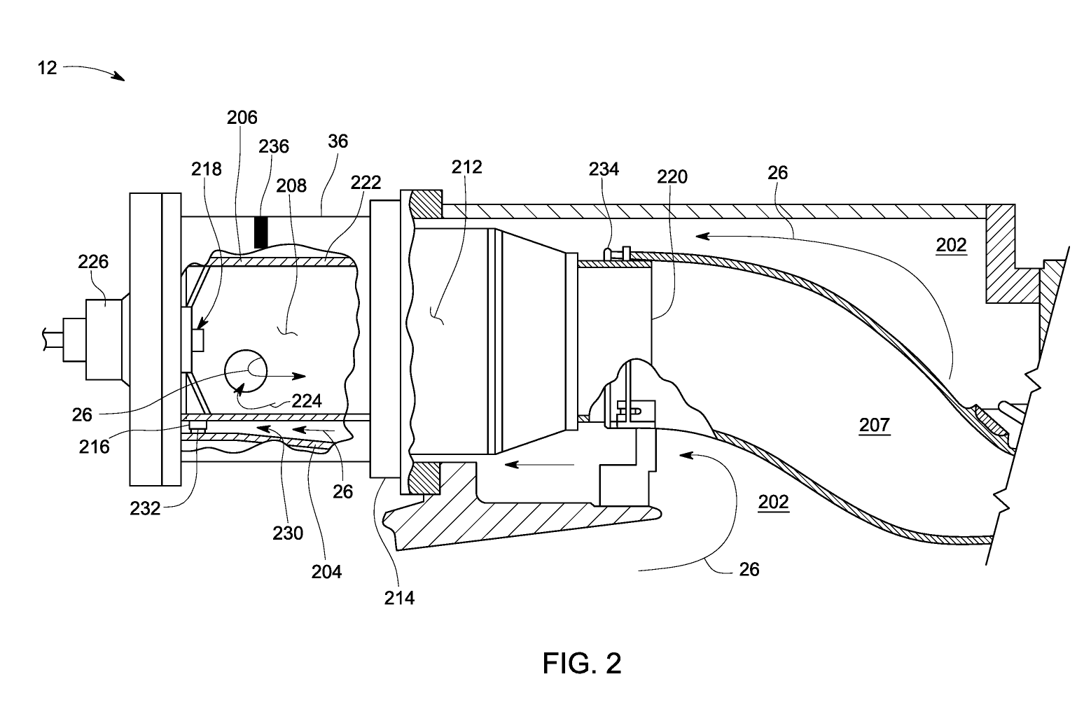

FIG. 2 is a partial sectional view of the combustor 12 shown in FIG. 1 in accordance with an embodiment the present invention. The combustor 12 includes a compressed air inlet duct 202, a flow sleeve 204, and a combustion gas exhaust duct 207 to direct combustion air to the turbine. The flow sleeve 204 houses a cylindrical combustion liner 206 that houses a combustion zone 208. The combustion liner 206 is coaxially mounted within the flow sleeve 204. The combustion liner 206 and the flow sleeve 204 are both coaxially mounted within the combustor casing 36. The flow sleeve 204 is mounted in the combustor casing 36, using mounting brackets 214. The cylindrical combustor casing 36 houses one or more combustion chambers 212.

The combustion liner 206 has an inlet end 216 aligned with a fuel injection nozzle 218 and an exhaust end 220 coupled to the combustion gas exhaust duct 207. A cylindrical wall 222 of the combustion liner 206 defines the combustion zone 208. The cylindrical wall 222 includes air apertures 224 to allow the compressed air 26 to flow into the combustion zone 208 for combustion and cooling. Fuel is fed to the fuel injection nozzle 218 through a fuel inlet port 226. Compressed air 26 flows from the compressor 16 (see FIG. 1) to the compressed air inlet duct 202 of the combustion chamber 212 and then passes through an annular air passage 230 formed between the combustion liner 206 and flow sleeve 204. The compressed air 26 flowing through the air passage 230, cools the combustion liner 206 and enters the combustion zone 208 via the air apertures 224 and mixed with fuel for combustion. The combustion liner 206 is held in the flow sleeve 204 by liner stoppers 232 adjacent the inlet end 216 of the combustion liner 206. The combustion liner 206 is also supported by a coupling 234 that attaches the exhaust end 220 of the combustion liner 206 to the exhaust duct 207. The liner stoppers 232, for example, may be symmetrically arranged around the outer surface of the cylindrical combustion liner 206. Casing stoppers 236 may be disposed between the casing 36 and the flow sleeve 204.

Acoustic emission waves, for example, are generated due to fretting wear between the combustion liner 206 and the liner stoppers 232, and/or fretting wear between the casing stoppers 236 and the casing 36 of the combustor 12. The acoustic emission waves, for example may also be generated due to fretting wear between the liner stoppers 232 and the flow sleeve 204, and/or the fretting wear between the casing stoppers 236 and the flow sleeve 204. For example, fretting wear may result in changes in the structure of the combustion liner 206, the liner stoppers 232 and the flow sleeve 204, resulting in generation of the acoustic emission waves.

FIG. 3 is a flow chart that illustrates an exemplary method 300 for monitoring the fretting wear of a combustor of a gas turbine engine in accordance with one embodiment of the present invention. At block 302, acoustic emission waves are sensed and an electrical signal is generated based on the sensed acoustic emission waves. The acoustic emission waves, for example, may be acoustic emission waves that are transmitted through a casing of the combustor. For example, a sensing device installed on the casing of the combustor senses the acoustic emission waves to generate the electrical signal. The acoustic emission waves, for example, are generated due to fretting wear between a combustion liner and liner stoppers, and/or fretting wear between casing stoppers and the casing of the combustor. The acoustic emission waves, for example may also be generated due to fretting wear between the liner stoppers and a flow sleeve, and/or the fretting wear between the casing stoppers and the flow sleeve. The acoustic emission waves sensed by the sensing device, for example, may be characterized by a frequency range of 100 kHz to 1.5 MHz.

Furthermore, at block 304, one or more features may be determined based on the electrical signal. The features, for example may include one or more of burst amplitude, burst energy, and burst count. An example of determination of features is shown with reference to FIG. 5. In certain embodiments, the electrical signal may be divided into a plurality of predefined fretting wear cycles, and the features may be determined for each of the fretting wear cycles. Fretting is typically defined as a special wear process that occurs at a contact area between two materials under load and subject to minute relative motion by vibration or some other force. The amplitude of the vibration is very small, less than few millimeters. Each oscillation cycle of the vibratory motion, under load, that causes wear between two interacting material surfaces is defined as a “fretting wear cycle”.

Furthermore, at block 306, a presence or an absence of the fretting wear may be determined based on one or more of the features. For example, one or more of the features may be correlated to a threshold value to determine the presence or the absence of the fretting wear in the combustor. For example, burst amplitude A may be compared to a respective threshold value T₁. If the burst amplitude A exceeds the threshold value T₁, it may be determined that fretting wear exists in the combustor. Similarly, burst count may be compared to a respective threshold value T₂. If the burst count exceeds the threshold value T₂, it may be determined that the fretting wear exists in the combustor. Similarly, when the burst energy exceeds a threshold value T₃, it may be determined that the fretting wear exists in the combustor.

In certain embodiments, at block 308 wear volume in one or more components of the combustor may be determined. As used herein, the term “wear volume” refers to an amount of wear caused in one or more components of the combustor due to fretting wear. For example, the amount of wear-volume may be determined based on the features. Particularly, the amount of wear-volume may be determined based on an amount of deviation of the features from respective thresholds. Subsequently at step 310, when the fretting wear exists in the combustor, an operator or user may repair the combustor by replacing or repairing one or more components of the combustor.

FIG. 4 is a flow chart that illustrates an exemplary method 400 for monitoring the fretting wear of a combustor of a gas turbine engine in accordance with another embodiment of the present invention. At block 402, acoustic emission waves are sensed and an electrical signal is generated based on the sensed acoustic emission waves. The acoustic emission waves, for example, may be acoustic emission waves that are transmitted through a casing of the combustor. A sensing device installed on a casing of the combustor senses the acoustic emission waves and generates the electrical signal. The acoustic emission waves, for example, are generated due to fretting wear between a combustion liner and liner stoppers, and/or fretting wear between casing stoppers and the casing of the combustor. The acoustic emission waves, for example may also be generated due to fretting wear between the liner stoppers and a flow sleeve, and/or the fretting wear between the casing stoppers and the flow sleeve. The acoustic emission waves sensed by the sensing device, for example, may be characterized by a frequency range of 100 kHz to 1.5 MHz.

Furthermore, at block 404 the electrical signal is amplified to generate a low impedance electrical signal. The amplification, for example, may be executed by an electronic equipment, an electronic device, an electronic circuit or a module of a processing subsystem. At block 406, the low impedance electrical signal is filtered to generate a filtered electrical signal. Subsequently, at block 408, the filtered electrical signal is sampled to generate a discrete electrical signal.

Additionally at block 410, one or more features are determined based on the discrete electrical signal. The features, for example, may include one or more of a burst amplitude, a burst energy, and burst count. Subsequently, at block 412, a presence or absence of the fretting wear may be determined based on one or more of the features. For example, one or more of the features is correlated to a threshold value to determine the presence or the absence of the fretting wear in the combustor. Subsequently at step 414, if the fretting wear exists in the combustor, an operator or user may repair the combustor by replacing or repairing one or more components of the combustor.

FIG. 5 is an example of a simulated electrical signal 500 for determining one of more time domain features, in accordance with one embodiment of the present invention. The electrical signal 500, for example may be the electrical signal 40 referred to in FIG. 1. In one embodiment, the electrical signal 500 may be the discrete electrical signal 54 referred to in FIG. 1. X-axis 502 is representative of time stamp, and Y-axis 504 is representative of voltage and amplitude. Furthermore reference numeral 506 is representative of a predetermined voltage threshold. As shown in FIG. 5, a peak 508 has maximum amplitude, hence amplitude of the peak 508 is representative of a feature namely burst amplitude. Additionally in the example of FIG. 5, the electrical signal 500 exceeds or crosses the predetermined voltage threshold 506 five times, hence the burst count of the electrical signal 500 is five. Also, the burst energy of the electrical signal 500, for example may be determined based on an area of the portion 510 of electrical signal 500 that crosses or exceeds the predetermined voltage threshold 506.

Embodiments of the present system and method disclose monitoring the fretting wear of a combustor without dismantling the gas turbine engine. Further, embodiments of the present system and method disclose an online estimate of wear in a combustor or one or more components of the combustor including liner stopper, casing, casing topper, or the like, thereby preventing early failures and unscheduled outages.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a casing;
a combustor disposed within the casing;
a sensing device located on the casing and configured to sense a plurality of acoustic emission waves and generate an electrical signal based on the sensed plurality of acoustic emission waves; and
a processing subsystem operationally coupled to the sensing device and configured to:
determine one or more features based on the electrical signal; and
determine a presence or an absence of fretting wear in the combustor based at least on the one or more features.

2. The system of claim 1, wherein the processing subsystem is further configured to determine the presence or the absence of the fretting wear in the combustor by correlating the one or more features to a threshold value.

3. The system of claim 1, further comprising a gas turbine engine comprising the combustor.

4. The system of claim 3, wherein the processing subsystem is further configured to determine the presence or the absence of the fretting wear in the combustor based on a load of the gas turbine engine.

5. The system of claim 1, wherein the combustor comprises a casing stopper, a combustion liner, a liner stopper, or combinations thereof.

6. The system of claim 5, wherein the plurality of acoustic emission waves are generated due to the fretting wear between the liner stopper and the combustion liner or the casing stopper and the casing.

7. The system of claim 6, wherein the plurality of acoustic emission waves are generated due to the fretting wear between the combustion liner and the liner stopper of the combustor, the fretting wear between the combustion liner and the casing stopper of the combustor, or a combination thereof.

8. The system of claim 1, wherein the processing subsystem further comprises:
an amplifying device coupled to the sensing device and configured to amplify the electrical signal to generate a low impedance electrical signal;
a filtering device coupled to the amplifying device and configured to filter the low impedance electrical signal to generate a filtered electrical signal; and
a sampler coupled to the filtering device and configured to sample the filtered electrical signal to generate a discrete electrical signal.

9. The system of claim 8, wherein the processing subsystem is further configured to determine the one or more features based on the discrete electrical signal, and wherein the filtered electrical signal is characterized by a frequency range of about 100 kHz to about 500 kHz.

10. The system of claim 1, wherein the one or more features comprise a burst amplitude, a burst energy, and a burst count.

11. The system of claim 10, wherein the processing subsystem is further configured to determine a wear-volume of one or more components in the combustor based on the burst amplitude, the burst energy and the burst count.

12. The system of claim 1, wherein the processing subsystem is further configured to:
divide the electrical signal into a plurality of predefined fretting wear cycles; and
determine the one or more features for each of the plurality of predefined fretting wear cycles.

13. A method for determining fretting wear in a combustor, the method comprising:
sensing a plurality of acoustic emission waves;
generating an electrical signal based on the sensed plurality of acoustic emission waves;
determining one or more features based on the electrical signal; and
determining a presence or an absence of the fretting wear in the combustor based at least on the one or more features.

14. The method of claim 13, further comprising determining the presence or the absence of the fretting wear in the combustor by correlating the one or more features to a threshold value.

15. The method of claim 13, further comprising determining the presence or the absence of the fretting wear in the combustor based on a load of a gas turbine engine comprising the combustor.

16. The method of claim 13, further comprising:
amplifying the electrical signal to generate a low impedance electrical signal;
filtering the low impedance electrical signal to generate a filtered electrical signal; and
sampling the filtered electrical signal to generate a discrete electrical signal.

17. The method of claim 16, further comprising determining the one or more features based on the discrete electrical signal, and wherein the filtered electrical signal is characterized by a frequency range of about 100 kHz to about 500 kHz.

18. The method of claim 13, wherein the one or more features comprise a burst amplitude, a burst energy, and burst count.

19. The method of claim 18, further comprising determining wear-volume of one or more components in the combustor based on the burst amplitude, the burst energy and the burst count.

20. The method of claim 13, further comprising:
dividing the electrical signal into a plurality of predefined fretting wear cycles; and
determining the one or more features for each of the plurality of predefined fretting wear cycles.
